(19) United States
(12) Patent Application Publication
(10) Pub. No.: US 2012/0048003 A1
(43) Pub. Date: Mar. 1, 2012

(54) VITAMIN ASSAY METHODS

(75) Inventor: Bruce Alan Golden, Hewlett Harbor, NY (US)

(73) Assignee: GOLDEN PRODUCTS LLC, Limited Liability Company, Howard Beach, NY (US)

(21) Appl. No.: 13/205,089

(22) Filed: Aug. 8, 2011

Related U.S. Application Data
(60) Provisional application No. 61/376,485, filed on Aug. 24, 2010.

(51) Int. Cl. G01N 30/02

(52) U.S. Cl. 73/61.52

(57) ABSTRACT

A method for performing an assay of at least one target vitamin in an oral care product includes: a) preparing a first analyte comprising a standard solution of the target vitamin to be assayed; b) preparing a second analyte comprising a sample solution derived from the oral care product containing the target vitamin; c) preparing a third analyte comprising a placebo solution derived from the oral care product which does not contain the target vitamin; d) chromatographically analyzing and providing a chromatogram for each said analyte; e) comparing the chromatograms of the first and second analytes to determine the amount of target vitamin in the sample solution; and f) comparing the chromatograms of the second and third analytes to verify that the assay is specific for the target vitamin.

### CROSS REFERENCE TO RELATED APPLICATIONS

The present application claims priority to U.S. Provisional application No. 61/376,485 filed Aug. 24, 2010, which is herein incorporated by reference in its entirety.

### BACKGROUND

1. Field of the Invention

The present application is directed to methods for providing an assay of vitamins in oral care formulations such as toothpaste, mouthwash and the like.

2. Background of the Art

Oral hygiene products, such as toothpastes, have been in use for many years. Toothpastes generally include an abrasive material, which is dispersed in a gel or paste base. Abrasives remove stains and plaque, as well as polish teeth. Common abrasives include calcium phosphates, alumina, calcium carbonate, and silica. Toothpaste must be abrasive enough to remove plaque and stains, but should not be so abrasive as to damage tooth enamel.

Fluoride is typically added to toothpaste in order to reduce tooth decay. In particular, fluoride incorporates itself into tooth enamel to make teeth more resistant to acids produced by plaque bacteria, as well as acids found in fruit juices, soda and certain foods. Indeed, toothpastes containing fluoride hardens tooth enamel to make the entire tooth structure more resistant to decay and promote remineralization, which aids in repairing early decay. In toothpaste, fluoride is commonly found in the form of sodium monofluorophosphate, stannous fluoride, or sodium fluoride. Notably, due to the toxicity of fluoride, the Food and Drug Administration (FDA) regards any toothpaste containing fluoride as a drug. Accordingly, the FDA requires a warning on the label of any toothpaste containing fluoride stating “If you accidentally swallow more than used for brushing, seek professional help or contact a poison control center immediately.” Moreover, the American Dental Association (ADA) requires that toothpaste manufacturers include the following language on all ADA-Accepted toothpastes containing fluoride: “Do not swallow. Use only a pea-sized amount for children under six. To prevent swallowing, children under six years of age should be supervised in the use of toothpaste.” Clearly, toothpastes containing fluoride are not intended to, and should not, be swallowed.

Detergents may also be added to toothpastes to aid in cleaning. For example, detergents may be added to create a foaming action. Foam prevents toothpaste from dribbling out one's mouth during brushing. SLS (sodium lauryl sulfate) is a commonly used detergent.

Toothpastes may also include other ingredients such as, for example, humectants to prevent toothpaste from drying out, thickeners, and preservatives to prevent the growth of microorganisms, flavoring agents, sweeteners, and coloring agents.

At least some portion of a serving size of toothpaste is swallowed during brushing, even if not intended. The portion of the toothpaste that is swallowed, including any dietary ingredient(s) therein, is digested in the gastrointestinal tract. Known toothpastes that include vitamins and/or minerals, however, fail to provide the vitamins and/or minerals such as, B-complex of vitamins, Vitamin C, and calcium, for example, in an amount sufficient to be considered a “significant source” of the dietary supplement(s) included therein.

The term “dietary supplement” was defined in the Dietary Supplement Health and Education Act (DSHEA) of 1994. In short, a dietary supplement is a product taken orally that contains a dietary ingredient intended to supplement the diet. The dietary ingredients may include, for example, vitamins, minerals, herbs or other botanicals, amino acids, and substances such as enzymes, organ tissues, glandulars, and metabolites. Dietary supplements can also be extracts or concentrates, and may be found in many forms such as tablets, capsules, softgels, gelcaps, liquids, or powders. The DSHEA places dietary supplements in a special category under the general umbrella of foods, not drugs. In particular, if a product contains less than 2 percent of the reference daily intake (RDI) of a given dietary supplement, that product is not a “significant source” of that dietary supplement.

It would be advantageous to provide a toothpaste that provides a significant source of at least one dietary supplement, such as a vitamin and/or a mineral and does not include fluoride. That is, a non-fluoride toothpaste containing more than 2 percent of the reference daily intake (RDI) of a given dietary supplement that is safe to swallow and supplements the diet of a mammal when ingested is needed on the market today. However, what is needed are methods to assay the vitamins in the toothpaste to determine their amounts. The present invention provides such methods and which are further described in the sections below.

### SUMMARY OF THE INVENTION

A method for performing an assay of at least one target vitamin in an oral care product is provided herein, said method comprising: (a) preparing a first analyte comprising a standard solution of the target vitamin to be assayed; (b) preparing a second analyte comprising a sample solution derived from the oral care product containing the target vitamin; (c) preparing a third analyte comprising a placebo solution derived from the oral care product which does not contain the target vitamin; (d) chromatographically analyzing and providing a chromatogram for each said analyte; (e) comparing the chromatograms of the first and second analytes to determine the amount of target vitamin in the sample solution; and, (f) comparing the chromatograms of the second and third analytes to verify that the assay is specific for the target vitamin.

In an embodiment the oral care product is toothpaste. Target vitamins include Vitamin D3, Vitamin E, Vitamin B5, Niacinamide and Pyridoxine HCl.

### BRIEF DESCRIPTION OF THE DRAWINGS

Various embodiments are described below with reference to the drawings wherein:

FIGS. 1A to 1C illustrate the chromatographic results of a Vitamin D3 assay wherein FIG. 1A is the chromatogram for the standard solution, FIG. 1B is the chromatogram for the toothpaste, and FIG. 1C is the chromatogram for the placebo.

FIGS. 2A to 2C illustrate the chromatographic results of a Vitamin E assay wherein FIG. 2A is the chromatogram for the standard solution, FIG. 2B is the chromatogram for the toothpaste, and FIG. 2C is the chromatogram for the placebo.

FIGS. 3A to 3C illustrate the chromatographic results of a Vitamin B5 (pantothenic acid) assay wherein FIG. 3A is the chromatogram for the standard solution, FIG. 3B is the chromatogram for the toothpaste, and FIG. 3C is the chromatogram for the placebo.

FIGS. 4A to 4C illustrate the chromatographic results of a Niacinamide and Pyridoxine HCl assay wherein FIG. 4A is the chromatogram for the standard solution, FIG. 4B is the chromatogram for the toothpaste, and FIG. 4C is the chromatogram for the placebo.

### DETAILED DESCRIPTION OF PREFERRED EMBODIMENT(S)

Other than in the working examples or where otherwise indicated, all numbers expressing amounts of materials, reaction conditions, time durations, quantified properties of materials, and so forth, stated in the specification and claims are to be understood as being modified in all instances by the term “about.”

It will also be understood that any numerical range recited herein is intended to include all sub-ranges within that range.

It will be further understood that any compound, material or substance which is expressly or implicitly disclosed in the specification and/or recited in a claim as belonging to a group of structurally, compositionally and/or functionally related compounds, materials or substances includes individual representatives of the group and all combinations thereof.

As used in the specification and including the appended claims, the singular forms “a,” “an,” and “the” include the plural, and reference to a particular numerical value includes at least that particular value, unless the context clearly dictates otherwise.

It is also understood that all spatial references, such as, for example, horizontal, vertical, top, upper, lower, bottom, left and right, are for illustrative purposes only and can be varied within the scope of the disclosure. For example, the references “upper” and “lower” are relative and used only in the context to the other, and are not necessarily “superior” and “inferior”.

All methods described herein may be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

As used herein, “comprising,” “including,” “containing,” “characterized by,” and grammatical equivalents thereof are inclusive or open-ended terms that do not exclude additional, unrecited elements or method steps, but will also be understood to include the more restrictive terms “consisting of” and “consisting essentially of.”

The present invention may be understood more readily by reference to the following detailed description of the present invention, which forms a part of this disclosure. It is to be understood that the present invention is not limited to the specific devices, methods, conditions or parameters described and/or shown herein, and that the terminology used herein is for the purpose of describing particular embodiments by way of example only and is not intended to be limiting of the claimed invention.

In one embodiment, a non-fluoride containing toothpaste is enriched with at least one dietary supplement comprises a gum base, a thickening agent, at least one dietary supplement selected from the group consisting of Vitamin B1, Vitamin B6, Vitamin A, Vitamin D3, Vitamin E, niacinamide, Vitamin B12, D-calcium pantothenate and mixtures thereof. In addition the non-fluoride toothpaste can also comprise at least one component selected from the group consisting of sodium selenate, manganese chloride, zinc lactate, magnesium sulfate, sea salt, tetrasodium pyrophosphate and mixtures thereof. The non-fluoride containing toothpaste may further comprise a preservative and/or a flavoring agent.

In another embodiment, the non-fluoride containing toothpaste can comprise sodium saccharin, EDTA, sodium benzoate, stevia, xylitol, a polymer of ethylene oxide generally having the formula H(OCH₂CH₂)ₙOH wherein n has an average number of about 8 (PEG-8), glycerin, propylparaben, titanium dioxide, sorbitol, a precipitated amorphous silica, natural spearmint oil, sodium lauryl sulfate, and mixtures thereof.

Only a certain amount of dietary supplements, such as vitamins and/or minerals, may be incorporated as ingredients in the paste of the final toothpaste product without rendering the final toothpaste product insufficient as a toothpaste. For example, if the amount of vitamins and/or minerals incorporated as ingredients in the paste of the final toothpaste product exceeds a certain threshold, the vitamins and/or minerals may precipitate out of the paste, may become too runny or may have a foul taste and/or smell. Indeed, the degradation of certain vitamins and minerals has been found to cause discoloration because the degradation products produced by the exposure to air, for example, are a different color than the original compound. Therefore, assay methods are provided herein for determining the amount of vitamins in the toothpaste.

The assay methods described below for determining the quantity of vitamin in the toothpaste sample vary according to the specific vitamin being assayed. In general, however, each method includes the steps of solvent extraction of the vitamin from a sample with a specified extraction solution, measuring the amount of the vitamin using themiospray (TSP) mass spectrometry in series with a UV absorbance detector to develop chromatograms for the extracted samples, and also for a standard solution and a placebo (toothpaste without the vitamin being measured).

The amount of the vitamin can be calculated from the chromatographic results, and comparison of the chromatograms provides a confirmation of the accuracy of the assay.

### EXAMPLES

### Vitamin D3 Assay

The method described herein provides a determination of Vitamin D3 in a sample of toothpaste with minerals. The assay system employed should have a relative standard deviation (“RSD”) of no more than 3.0%, a tailing factor (T_{f}) of no more than 2.0, and duplicate standards should be within 3.0% of each other. Suitable equipment for conducting this analysis includes a TSP Spectra Series P4000 pump, a Water Series 717 plus autosampler, a TSP Spectra Series UV1000 detector and Lab Systems Atlas Data Handling system. A C8 chromatography column (25 cm×4.6 mm inner diameter; 5 micron size) can be used for liquid chromatography separation. The column is first flushed with the mobile phase solution described below to condition the column prior to the injection of the analyte solution.

The following working solutions are employed.

A mobile phase solution is prepared by mixing 940 mL acetonitrile, 940 mL methanol, 120 mL water and 0.5 mL glacial acetic acid. An extracting solution is made by mixing 750 mL of isopropanol with 250 mL of 1% acetic acid/water solution.

Three analyte solutions were prepared as follows.

First, a standard Vitamin D3 solution is prepared by adding 28 mg of cholecalciferol into a 100 mL volumetric flask. Then, 50 mL of extracting solution is added and the mixture sonicated for 5 minutes. More extracting solution is added to bring the volume to 100 mL. A second solution is provided by diluting 2.0 mL of this solution to 100 mL with extraction solution. Then 4.0 ml of the second solution are diluted to 100 mL with extraction solution to provide a third solution. 3 mL of the third solution are then diluted with extraction solution to 10 mL to provide a final standard solution having a concentration of 2.7 IU/mL of Vitamin D3, where one IU is equivalent to 0.025 micrograms Vitamin D3.

The sample solution is prepared by adding 2.5 grams of the sample toothpaste into a 25 mL volumetric flask. 15 mL of extracting solution is added and the mixture sonicated for 5 minutes. Then the mixture is mechanically agitated for an hour and enough extracting solution is added to bring the mixture to 25 mL volume. The mixture is again agitated and then centrifuged at 3000 RPM for 15 minutes. The clear supernatant fluid is then drawn off to provide the sample solution.

The placebo solution is made in the same manner as the sample solution except that a placebo toothpaste (without Vitamin D3) is used.

The three analyte solutions (standard, sample, and placebo) are then analyzed in accordance with the analytical method described above and chromatograms provided which show response peaks vs. retention time. The amount of Vitamin D3 in the sample is calculated in accordance with the formula:

$$IU Vitamin D 3 \text{/} \text{g} = \frac{{C}_{std} \times {P}_{std} \times 25 mL \times 40 \text{,} 000 IU \text{/} mg \times {A}_{smp}}{{A}_{std} \times {W}_{smp}}$$

where

C_{std}=Concentration of standard solution (mg/mL)

P_{std}=Purity of standard solution

Aₛₘₚ=Area of sample solution

A_{std}=Area of standard solution

Wₛₘₚ=Weight of sample in (grams)

The placebo chromatogram is compared with the sample chromatogram to determine whether any peaks in the placebo chromatogram would interfere with the Vitamin D3 peaks in the sample. If there are no interfering peaks the method is determined to be specific to Vitamin D3.

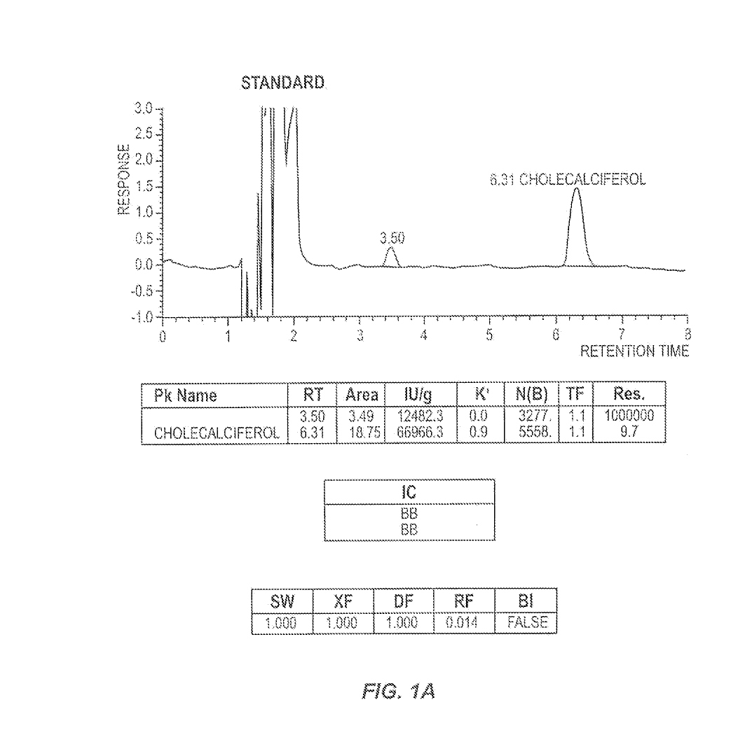

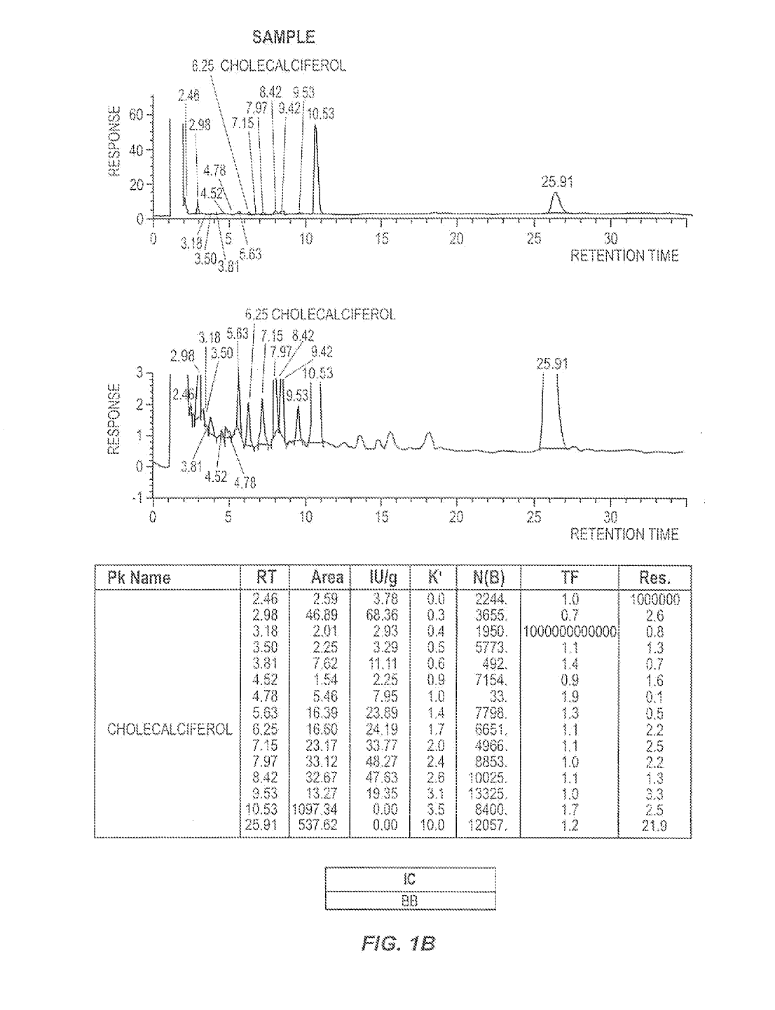

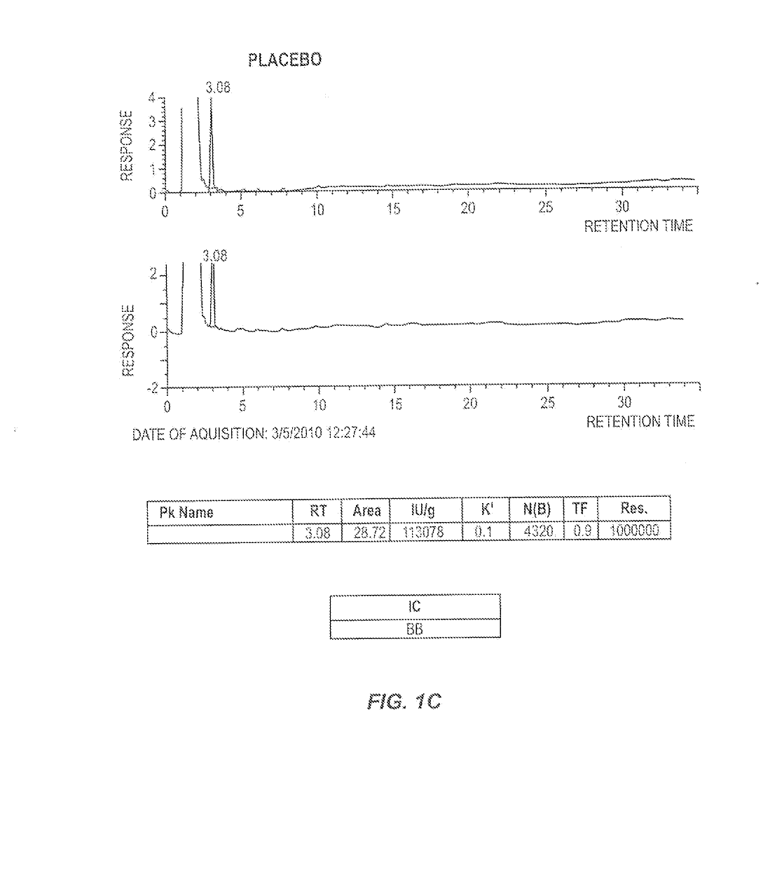

A toothpaste sample was analyzed in accordance with the method describe above. The chromatographic results are illustrated in FIGS. 1A, 1B and 1C, wherein FIG. 1A is the chromatogram for the standard solution, FIG. 1B is the chromatogram for the toothpaste, and FIG. 1C is the chromatogram for the placebo. As can be seen, the placebo has no peak near a retention time of 7 minutes which corresponds to cholecalciferol (Vitamin D3). This confirms that the test is specific to Vitamin D3. The standard solution (FIG. 1A) and the toothpaste sample (FIG. 1B) both exhibited peaks characteristic of cholecalciferol at retention times of 6.31 and 6.25 minutes, respectively.

### Vitamin E Assay

The method described herein provides a determination of Vitamin E in a sample of toothpaste with minerals. The assay system employed should have a relative standard deviation (“RSD”) of no more than 2.0%, a tailing factor (T_{f}) of no more than 2.0, and duplicate standards should be within 2.0% of each other. Suitable equipment for conducting this analysis includes an Agilent Series 1100 pump, Agilent Series 110 autosampler, an Agilent Series 110 detector and Lab Systems Atlas Data Handling system. A C8 chromatography column (25 cm×4.6 mm inner diameter; 5 micron size) can be used for liquid chromatography separation. The column is first flushed with the mobile phase solution described below to condition the column prior to the injection of the analyte solution. A Whatman 0.45 micron nylon filter is used.

The following working solutions are employed.

A mobile phase solution was prepared by mixing 940 mL acetonitrile, 940 mL methanol, 120 mL water and 0.5 mL glacial acetic acid. An extracting solution is made by mixing 750 mL of isopropanol with 250 mL of 1% acetic acid/water solution.

Three analyte solutions are prepared as follows.

First, a standard Vitamin E solution is prepared by adding 22 mg of Vitamin E acetate into a 100 mL volumetric flask. Then, 60 mL of extracting solution is added and the mixture sonicated for 20 minutes and shaken for 20 minutes. More extracting solution is added to bring the volume to 100 mL. The mixture was then filtered through the 0.45 mision fitter and diluted with 20/25 mL extraction solution to provide a final standard solution having a concentration of 0.18 mg/mL of Vitamin E acetate.

The sample solution is prepared by adding 6.5 grams of the sample toothpaste into a 50 mL volumetric flask. 30 mL of extracting solution is added and the mixture shaken for 20 minutes and sonicated for 20 minutes. Enough extracting solution is added to bring the mixture to 50 mL volume. The mixture is again filtered, discarding the first 3 mL to provide the sample solution.

The placebo solution is made in the same manner as the sample solution except that a placebo toothpaste (without Vitamin E) is used.

The three analyte solutions (standard, sample, and placebo) are then analyzed in accordance with the analytical method described above and chromatograms provided which show response peaks vs. retention time. The amount of Vitamin E in the sample is calculated in accordance with the formula:

$$Vitamin E Acetate mg \text{/} g = \frac{{C}_{std} \times {P}_{std} \times 50 mL \times {A}_{smp}}{{A}_{std} \times {W}_{smp}}$$

where

C_{std}=Concentration of standard solution (mg/mL)

P_{std}=Purity of standard solution

Aₛₘₚ=Area of sample solution

A_{std}=Area of standard solution

Wₛₘₚ=Weight of sample in (grams)

The placebo chromatogram is compared with the sample chromatogram to determine whether any peaks in the placebo chromatogram would interfere with the Vitamin E peaks in the sample. If there are no interfering peaks the method is determined to be specific to Vitamin E.

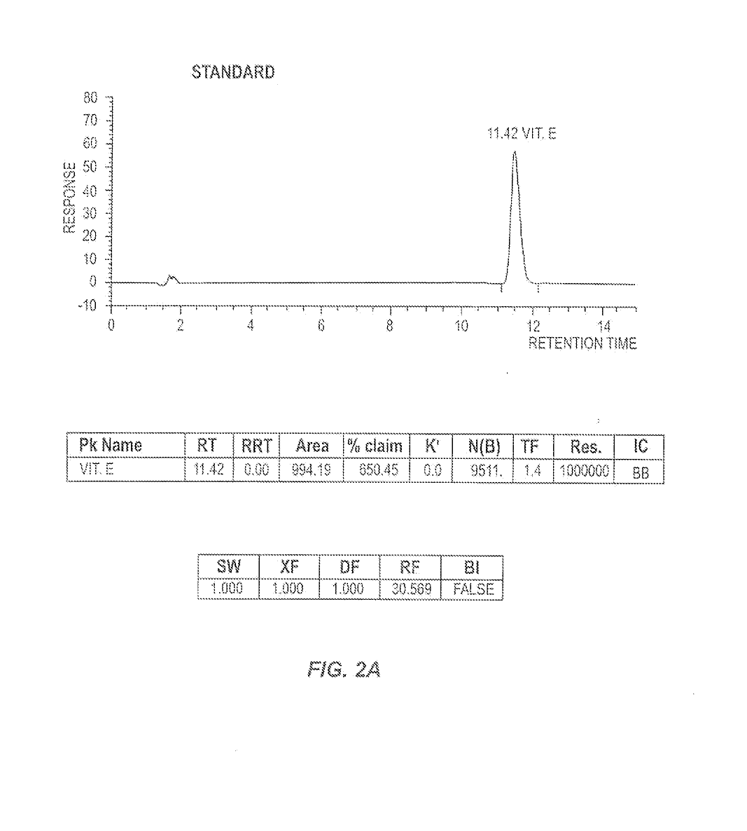

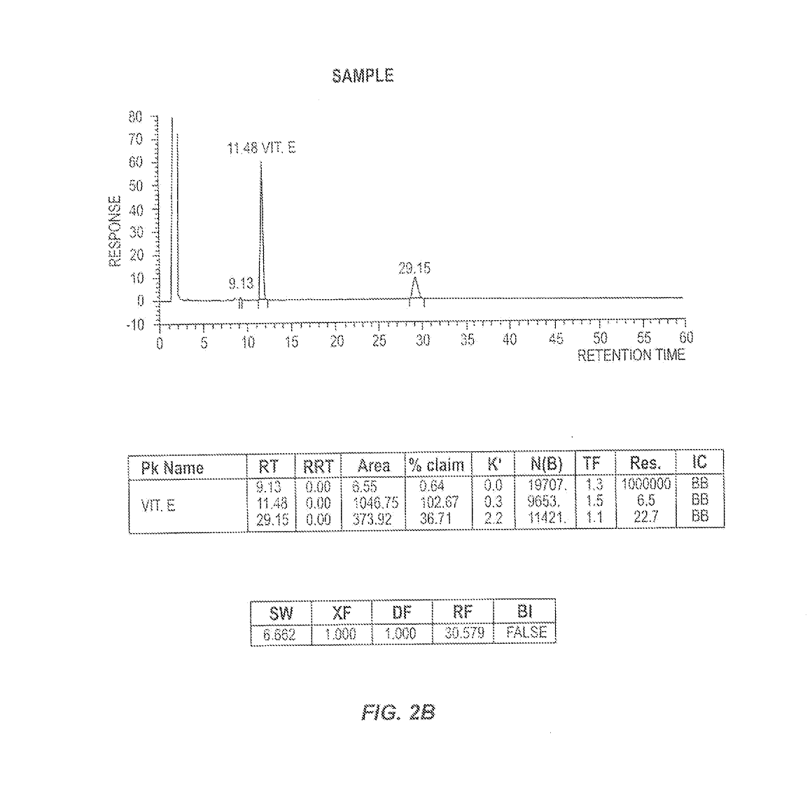

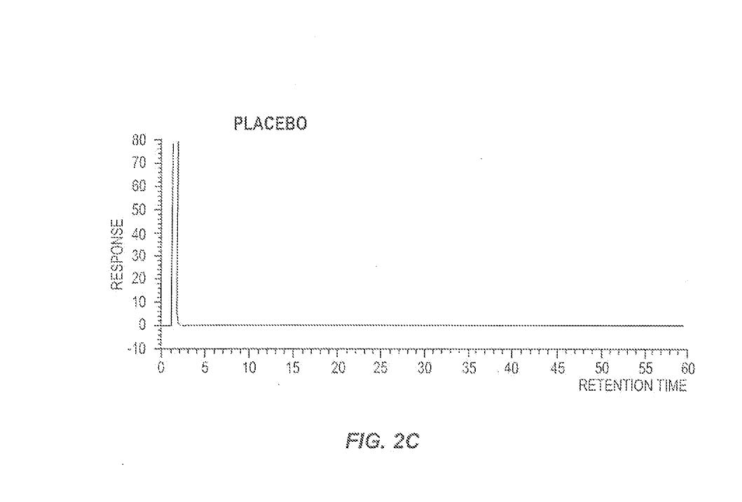

A toothpaste sample was analyzed in accordance with the method describe above. The chromatographic results are illustrated in FIGS. 2A, 2B and 2C, wherein FIG. 2A is the chromatogram for the standard solution, FIG. 2B is the chromatogram for the toothpaste, and FIG. 2C is the chromatogram for the placebo. As can be seen, the placebo has no peak near a retention time of 11 minutes which corresponds to Vitamin E. This confirms that the test is specific to Vitamin E. The standard solution (FIG. 2A) and the toothpaste sample (FIG. 2B) both exhibited peaks characteristic of Vitamin E acetate at retention times of 11.42 and 11.48 minutes respectively.

### Vitamin B5 (Pantothenic Acid) Assay

The method described herein provides a determination of Vitamin B5 in a sample of toothpaste with minerals. The assay system employed should have a relative standard deviation (“RSD”) of no more than 2.0%, a tailing factor (T_{f}) of no more than 2.0, and duplicate standards should be within 2.0% of each other. Suitable equipment for conducting this analysis include an TSP Spectra Series P4000, TSP Spectra Series AS3000 autosampler, a TSP Spectra Series UV2000 detector and Lab Systems Atlas Data Handling System for data processing. A C8 chromatography column (25 cm×4.6 mm inner diameter, 5 micron size) can be used for liquid chromatography separation. The column is first flushed with the mobile phase solution described below to condition the column prior to the injection of the analyte solution. A Whatman 0.45 micron nylon filter is used.

The following working solutions are employed.

A mobile phase solution was prepared by dissolving 136.1 g monobasic potassium phosphate in 1,800 mL water. Then 200 mL is added and mixed. The pH is then adjusted to 2.5 with phosphoric acid and the solution is filtered and degassed.

Three analyte solutions are prepared as follows.

First, a standard calcium pantothenate solution is prepared by dissolving 21.5 mg of calcium pantothenate in 100 mL water in a volumetric flask. Then, the solution is diluted 5/50 mL with water and mixed well.

The sample solution is prepared by adding 4.5 grams of the sample toothpaste to 75 mL water in a 100 mL volumetric flask, shaking the solution for 10 minutes then adding water to 100 mL volume and mixing well. The solution is then filtered through the Whatman 0.45 micron filter and 2 mL of the solution are discarded. to provide the sample solution.

The placebo solution is made in the same manner as the sample solution except that a placebo toothpaste (without Vitamin B5) is used.

The three analyte solutions (standard, sample, and placebo) are then analyzed in accordance with the analytical method described above and chromatograms provided which show response peaks vs. retention time. The amount of Vitamin B5 in the sample is calculated in accordance with the formula:

$$Pantothenic Acid mg \text{/} g = \frac{{C}_{std} \times {P}_{std} \times 100 mL \times {A}_{smp} \times 0.46}{{A}_{std} \times {W}_{smp}}$$

where

C_{std}=Concentration of standard solution (mg/mL)

P_{std}=Purity of standard solution

Aₛₘₚ=Area of sample solution

A_{std}=Area of standard solution

Wₛₘₚ=Weight of sample in (grams)

0.46=Ratio of the molecular weight of pantothenic acid (219.23) to the molecular weight of calcium pantothenate (476.53).

The placebo chromatogram is compared with the sample chromatogram to determine whether any peaks in the placebo chromatogram would interfere with the Vitamin B5 peaks in the sample. If there are no interfering peaks the method is determined to be specific to Vitamin B5.

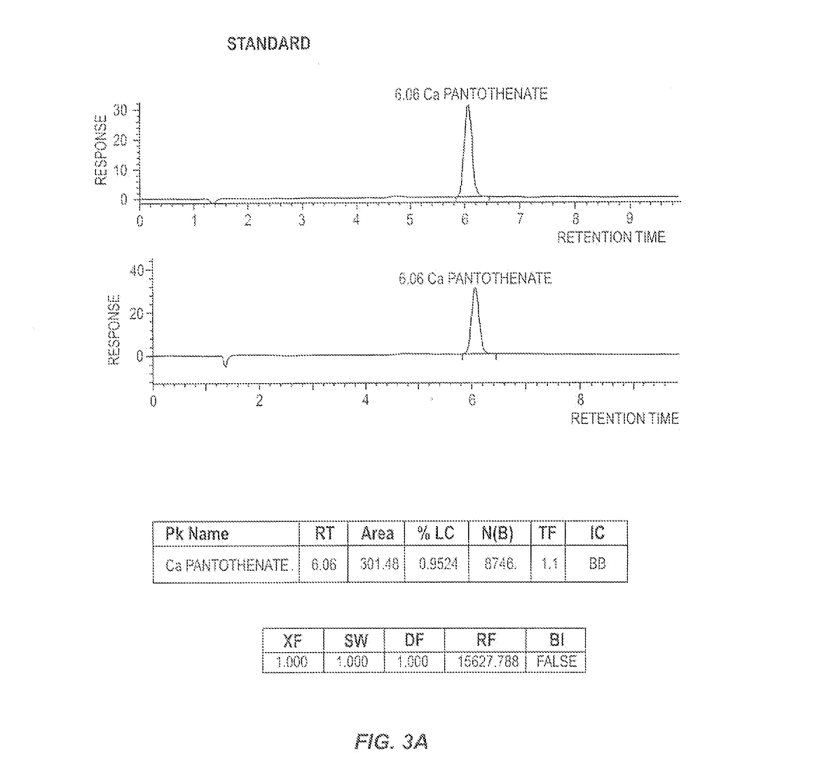

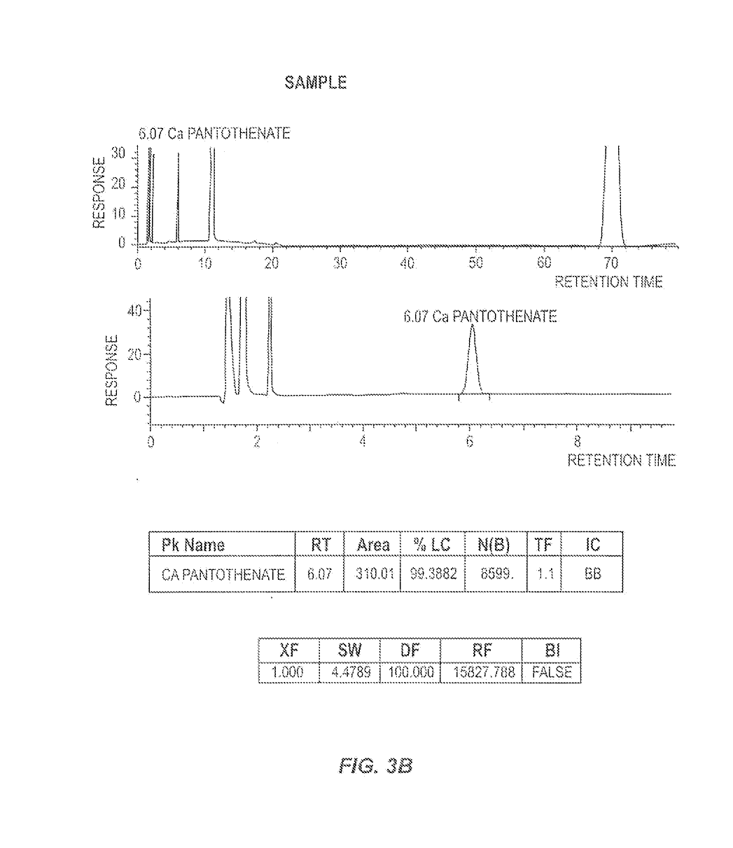

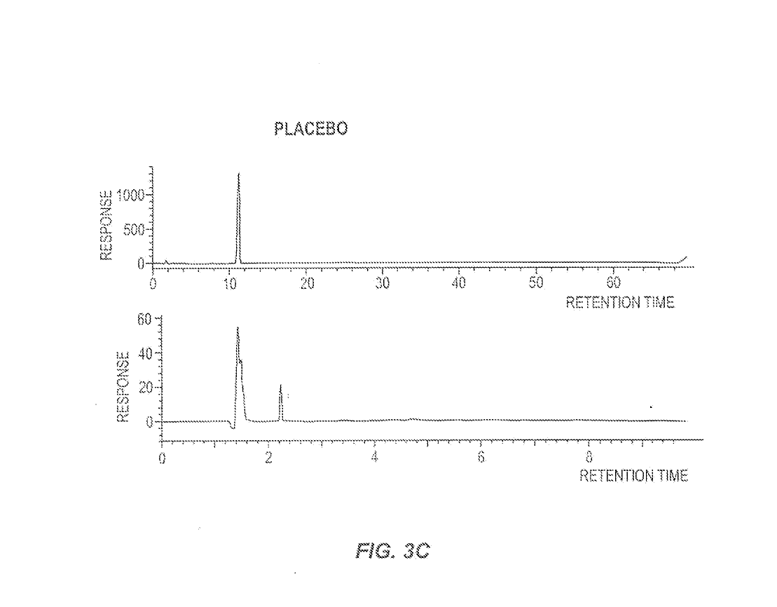

A toothpaste sample was analyzed in accordance with the method describe above. The chromatographic results are illustrated in FIGS. 3A, 3B and 3C, wherein FIG. 3A is the chromatogram for the standard solution, FIG. 3B is the chromatogram for the toothpaste, and FIG. 3C is the chromatogram for the placebo. As can be seen, the placebo has no peak near a retention time of 6.06 minutes which corresponds to Vitamin B5 (calcium pantothenate salt). This confirms that the test is specific to Vitamin B5. The standard solution (FIG. 3A) and the toothpaste sample (FIG. 3B) both exhibited peaks characteristic of Vitamin B5 at retention times of 6.06 and 6.07 minutes respectively.

### Niacinamide and Pyridoxine HCl Assay

The method described herein provides a determination of Niacinamide and Pyridoxine HCl in a sample of toothpaste with minerals. The assay system employed should have a relative standard deviation (“RSD”) of no more than 2.0%, a tailing factor (T_{f}) of no more than 2.0, and duplicate standards should be within 2.0% of each other. Suitable equipment for conducting this analysis include an TSP Spectra Series P4000, TSP Spectra Series AS3000 autosampler, a TSP Spectra Series UV2000 detector and Lab Systems Atlas Data Handling System for data processing. An Inertsil ODS-2 chromatography column (25 cm×4.6 mm inner diameter; 5 micron size) can be used for liquid chromatography separation. The column is first flushed with the mobile phase solution described below to condition the column prior to the injection of the analyte solution. A Whatman 0.45 micron nylon filter is used.

The following working solutions are employed.

A first mobile phase solution (Mobile Phase A) is prepared by dissolving 9 g monobasic potassium phosphate and 2.4 g of the sodium salt of heptane sulfonic acid in 1,660 mL water. The pH is adjusted to 3.0±0.05 with phosphoric acid. Then 340 mL methanol are added and the solution is mixed well, filtered and degassed.

Three analyte solutions are prepared as follows.

First, a standard solution is prepared by dissolving 40 mg of pyridoxine HCl in 100 mL Mobile Phase A solution in a first volumetric flask to provide a pyridoxine HCl stock solution. A niacinamide stock solution is prepared by dissolving 44 mg niacinamide in 100 mL Mobile Phase A solution in a second volumetric flask. Then, 1.0 mL of the pyridoxine HCl stock solution and 10.0 ml of the niacinamide stock solution are added to a third 100 mL volumetric flask and diluted to 100 mL volume with Mobile Phase A solution to provide the standard solution.

The sample solution is prepared by adding 2.5 grams of the sample toothpaste to 50 mL volumetric flask. Then 30 mL Mobile Phase A solution is added, the solution is shaken and then brought to 50 mL volume with more Mobile Phase A solution. The sample solution is then filtered through the Whatman 0.45 micron filter and 1 mL of the filtrate is discarded.

The placebo solution is made in the same manner as the sample solution except that a placebo toothpaste (without niacinamide or pyridoxine HCl) is used.

The three analyte solutions (standard, sample, and placebo) are then analyzed in accordance with the analytical method described above and chromatograms provided which show response peaks vs. retention time. The amount of niacinamide and pyridoxine HCl analyte in the sample is calculated in accordance with the formula:

$$Analyte mg \text{/} g = \frac{{C}_{std} \times {P}_{std} \times 50 mL \times {A}_{smp}}{{A}_{std} \times {W}_{smp}}$$

where

C_{std}=Concentration of standard solution (mg/mL)

P_{std}=Purity of standard solution

Aₛₘₚ=Area of sample solution

A_{std}=Area of standard solution

Wₛₘₚ=Weight of sample in (grams)

The placebo chromatogram is compared with the sample chromatogram to determine whether any peaks in the placebo chromatogram would interfere with the niacinamide or pyridoxine HCl peaks in the sample. If there are no interfering peaks the method is determined to be specific to niacinamide and pyridoxine HCl.

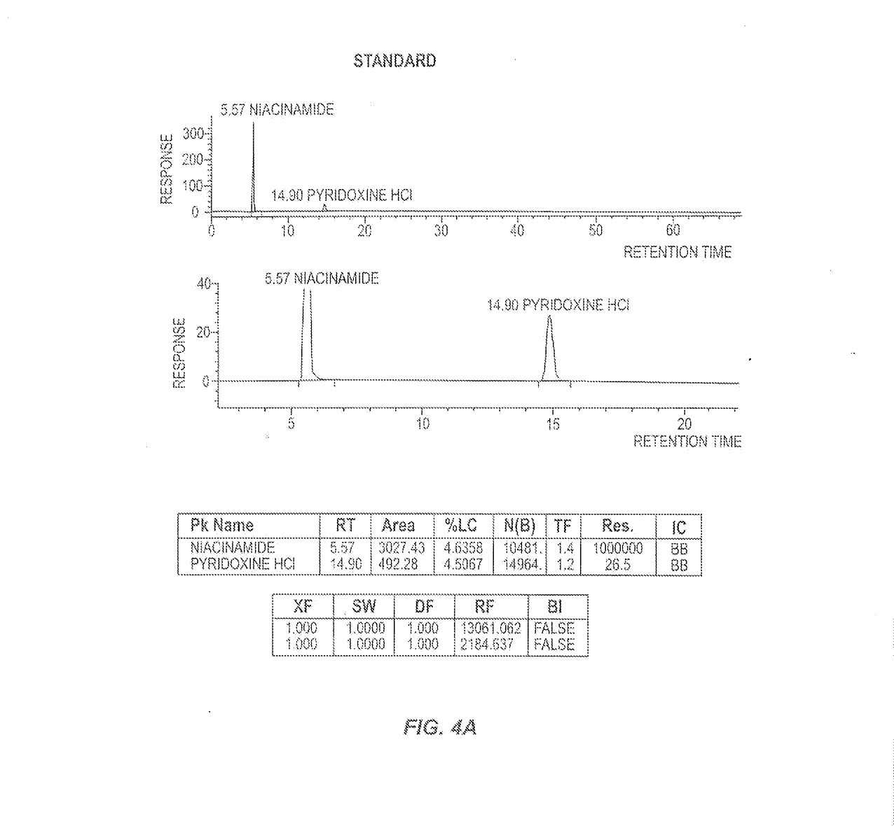

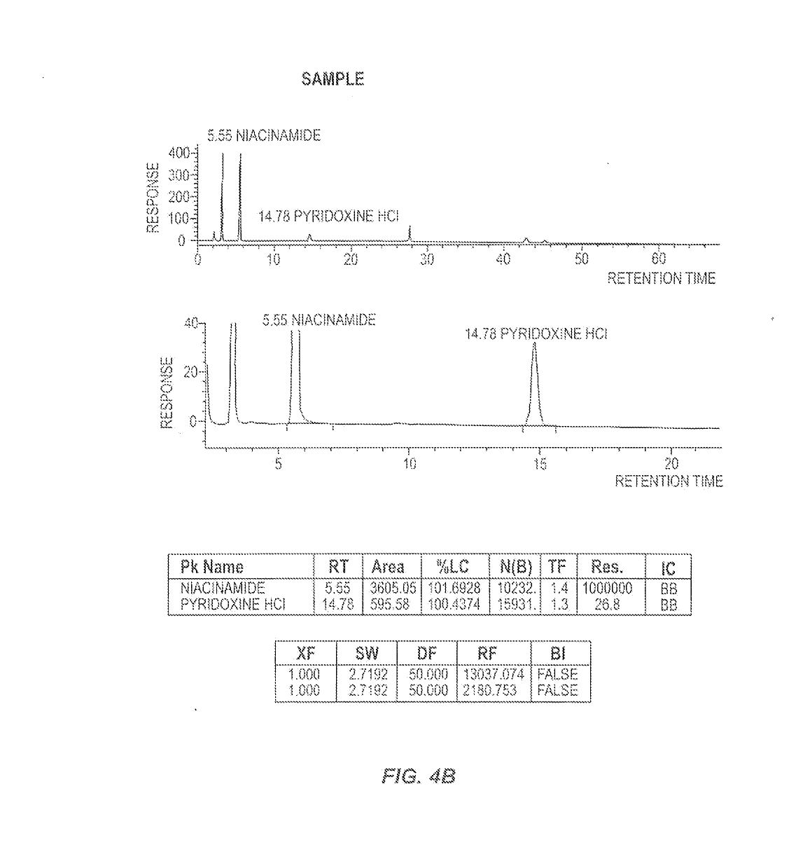

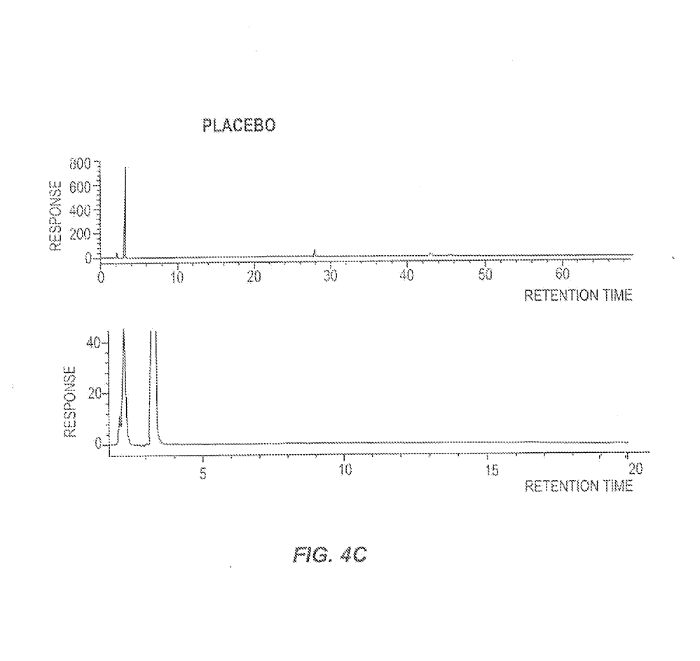

A toothpaste sample was analyzed in accordance with the method describe above. The chromatographic results are illustrated in FIGS. 4A, 4B and 4C, wherein FIG. 4A is the chromatogram for the standard solution, FIG. 4B is the chromatogram for the toothpaste, and FIG. 4C is the chromatogram for the placebo. As can be seen, the placebo has no peak near a retention time of 5.57 minutes or 14.9 minutes, which correspond respectively to niacinamide and pyridoxine HCl. This confirms that the test is specific to niacinamide and pyridoxine HCl. The standard solution (FIG. 3A) and the toothpaste sample (FIG. 3B) both exhibited peaks characteristic of niacinamide at retention times of about 5.57 and 5.55 respectively, and for pyridoxine HCl at retention times of 14.9 and 14.78 respectively.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. A method for performing an assay of at least one target vitamin in an oral care product, said method comprising:
a) preparing a first analyte comprising a standard solution of the at least one target vitamin to be assayed;
b) preparing a second analyte comprising a sample solution derived from the oral care product containing the at least one target vitamin;
c) preparing a third analyte comprising a placebo solution derived from the oral care product, which does not contain the at least one target vitamin;
d) chromatographically analyzing and providing a chromatogram for each said analyte;
e) comparing the chromatograms of the first and second analytes to determine the amount of the at least one target vitamin in the sample solution; and,
f) comparing the chromatograms of the second and third analytes to verify that the assay is specific for the at least one target vitamin.

2. The method of claim 1 wherein the oral care product is fluoride free toothpaste.

3. The method of claim 2 wherein the toothpaste contains one or more ingredients selected from the group consisting of sodium selenate, manganese chloride, zinc lactate, magnesium sulfate, sea salt, tetrasodium pyrophosphate, sodium saccharin, EDTA, sodium benzoate, stevia, xylitol, a polymer of ethylene oxide generally having the formula H(OCH₂CH₂)ₙOH wherein n has an average number of about 8 (PEG-8), glycerin, propylparaben, titanium dioxide, sorbitol, a precipitated amorphous silica, natural spearmint oil, sodium lauryl sulfate and mixtures thereof.

4. The method of claim 1 wherein the at least one target vitamin comprises one or more of Vitamin D3, Vitamin E, Vitamin B5, Niacinamide and/or Pyridoxine HCl, Vitamin B1, Vitamin B6, or Vitamin B12.

5. The method of claim 1 wherein the at least one target vitamin is vitamin D3 and the first analyte solution comprises a first predetermined amount of Vitamin D3 in a solution of isopropanol, acetic acid and water as a standard solution.

6. The method of claim 5 wherein the second analyte solution comprises a second predetermined amount of oral care product containing Vitamin D3 in a solution of isopropanol, acetic acid and water.

7. The method of claim 6 wherein the third analyte comprises the oral care product which does not contain the vitamin D3 in a solution of isopropanol, acetic acid and water.

8. The method of claim 7 wherein the first, second and third analyte solutions are analyzed and chromatograms provided which show response peaks vs. retention time, wherein the amount of Vitamin D3 in the sample is calculated in accordance with the formula:
$$IU Vitamin D 3 \text{/} \text{g} = \frac{{C}_{std} \times {P}_{std} \times 25 mL \times 40 \text{,} 000 IU \text{/} mg \times {A}_{smp}}{{A}_{std} \times {W}_{smp}}$$
where
C_{std}=Concentration of standard solution (mg/mL)
P_{std}=Purity of standard solution
Aₛₘₚ=Area of sample solution
A_{std}=Area of standard solution
Wₛₘₚ=Weight of sample in (grams),
and the placebo chromatogram is compared with the sample chromatogram to determine whether any peaks in the placebo chromatogram would interfere with the Vitamin D3 peaks in the sample.

9. The method of claim 1 wherein the at least one target vitamin is Vitamin E and the first analyte solution comprises a first predetermined amount of Vitamin E acetate in a solution of isopropanol, acetic acid and water as a standard solution.

10. The method of claim 9 wherein the second analyte solution comprises a second predetermined amount of oral care product containing Vitamin E acetate in a solution of isopropanol, acetic acid and water.

11. The method of claim 10 wherein the third analyte comprises the oral care product which does not contain Vitamin E acetate in a solution of isopropanol, acetic acid and water.

12. The method of claim 11 wherein the first, second and third analyte solutions are analyzed and chromatograms provided which show response peaks vs. retention time, wherein the amount of Vitamin E in the sample is calculated in accordance with the formula:
$$Vitamin E Acetate mg \text{/} g = \frac{{C}_{std} \times {P}_{std} \times 50 mL \times {A}_{smp}}{{A}_{std} \times {W}_{smp}}$$
where
C_{std}=Concentration of standard solution (mg/mL)
P_{std}=Purity of standard solution
Aₛₘₚ=Area of sample solution
A_{std}=Area of standard solution
Wₛₘₚ=Weight of sample in (grams),
and the placebo chromatogram is compared with the sample chromatogram to determine whether any peaks in the placebo chromatogram would interfere with the Vitamin E peaks in the sample.

13. The method of claim 1 wherein the at least one target vitamin is Vitamin B5 and the first analyte solution comprises a first predetermined amount of calcium pantothenate in water as a standard solution.

14. The method of claim 13 wherein the second analyte solution comprises a second predetermined amount of oral care product containing calcium pantothenate in water.

15. The method of claim 7 wherein the third analyte comprises the oral care product which does not contain calcium pantothenate in water.

16. The method of claim 15 wherein the first, second and third analyte solutions are analyzed and chromatograms provided which show response peaks vs. retention time, wherein the amount of pantothenic acid in the sample is calculated in accordance with the formula:
$$Pantothenic Acid mg \text{/} g = \frac{{C}_{std} \times {P}_{std} \times 100 mL \times {A}_{smp} \times 0.46}{{A}_{std} \times {W}_{smp}}$$
where
C_{std}=Concentration of standard solution (mg/mL)
P_{std}=Purity of standard solution
Aₛₘₚ=Area of sample solution
A_{std}=Area of standard solution
Wₛₘₚ=Weight of sample in (grams)
0.46=Ratio of the molecular weight of pantothenic acid (219.23) to the molecular weight of calcium pantothenate (476.53),
and the placebo chromatogram is compared with the sample chromatogram to determine whether any peaks in the placebo chromatogram would interfere with the Vitamin B5 peaks in the sample.

17. The method of claim 1 wherein the at least one target vitamin includes Niacinamide and Pyridoxine HCl and the first analyte solution comprises predetermined amounts of Niacinamide and Pyridoxine HCl in a solution of monobasic potassium phosphate, sodium salt of heptane sulfonic acid, phosphoric acid, water and methanol.

18. The method of claim 17 wherein the second analyte solution comprises a second predetermined amount of oral care product containing Niacinamide and Pyridoxine HCl in a solution of monobasic potassium phosphate, sodium salt of heptane sulfonic acid, phosphoric acid, water and methanol.

19. The method of claim 18 wherein the third analyte comprises the oral care product which does not contain the Niacinamide and Pyridoxine HCl in a solution of monobasic potassium phosphate, sodium salt of heptane sulfonic acid, phosphoric acid, water and methanol.

20. The method of claim 19 wherein the first, second and third analyte solutions are analyzed and chromatograms provided which show response peaks vs. retention time, wherein the amount of niacinamide and pyridoxine HCl analytes in the sample is calculated in accordance with the formula:
$$Analyte mg \text{/} g = \frac{{C}_{std} \times {P}_{std} \times 50 mL \times {A}_{smp}}{{A}_{std} \times {W}_{smp}}$$
where
C_{std}=Concentration of standard solution (mg/mL)
P_{std}=Purity of standard solution
Aₛₘₚ=Area of sample solution
A_{std}=Area of standard solution
Wₛₘₚ=Weight of sample in (grams)
The placebo chromatogram is compared with the sample chromatogram to determine whether any peaks in the placebo chromatogram would interfere with the niacinamide or pyridoxine HCl peaks in the sample.
